(19) United States
(12) Patent Application Publication
(10) Pub. No.: US 2020/0156846 A1
(43) Pub. Date: May 21, 2020

(54) STORAGE BAGS AND METHODS OF USE THEREOF

(71) Applicant: Matthias Riecker, Olching (DE)

(72) Inventor: Matthias Riecker, Olching (DE)

(21) Appl. No.: 16/193,181

(22) Filed: Nov. 16, 2018

(51) Int. Cl. B65D 81/18

(52) U.S. Cl. CPC B65D 81/18; A61J 1/00; B65D 2585/56

(57) ABSTRACT

A storage unit and method for providing heat transfer are disclosed. The storage unit is a storage bag and webs that are both made from the same film material. The storage bag has a top and a bottom surface having interior and exterior surfaces. The interior surface of both the top and bottom surface are connected by the webs. The webs will form channels through which a heat transfer medium can flow. The storage unit can contain bio-pharmaceutical products as well as other medical fluids that need to have heat transferred into or out of.

### BACKGROUND OF THE INVENTION

The freezing and thawing of large amounts of bulk liquids packed in flexible bags and/or rigid containers takes a long time due to limited cooling capacity of the freezing equipment, low overall heat transfer coefficient and the large size of the containers. This will affect the homogeneity of the products being frozen due to changes in product concentration throughout the container as it freezes.

Rapid or shock freezing is intended to alleviate these issues by reducing the freezing time and helping to maintain uniform concentrations, while quick thawing effectively converts the frozen product back to its liquid state so it can be readily used.

Current state-of-the-art fast freezing technologies utilize cabinet freezers and modified freeze dryers where packaged liquids are placed on or between cooled shelves, which are cooled using mechanical and sometimes cryogenic cooling systems and the volume of the product to be frozen. Freezing starts from outside to the inside of the product. The rate of freezing is determined by the overall thermal resistance of the systems which in can be high due to slow heat transfer through the packaging wall as the heat needs to pass through multiple protective layers designed to prevent damage as a result of contact with cold media as well as ineffective heat transfer on the inside of the package primarily due to natural convection. [There are commercial systems as well that agitate the bags together with the cooled shelves/plates.]

Pharmaceutical and medical products in fluid form are stored or matured in sterile plastic bags. This is achieved by cooling, freezing or heating and takes place in a freezer or incubator. The pharmaceutical or medical product inside of the bag will freeze or thaw from the outside to the inside with the inner portion itself heated or cooled the slowest.

This uneven temperature distribution across the bag can lead to quality losses of the product.

The present invention overcomes these difficulties by providing a more uniform energy distribution achieved across the entire cross section of the product being heated or cooled.

### SUMMARY OF THE INVENTION

In a first embodiment of the invention, there is disclosed a storage unit comprising a storage bag and webs, wherein the storage bag comprises a top and a bottom surface wherein the top and the bottom surfaces have an interior surface and an exterior surface and the top surface and the bottom surface each have edges wherein the edges are sealed together, and the webs are connected to the inner surface of the top surface and the inner surface of the bottom surface, wherein the storage bag and the webs are made from film materials that are the same.

In a second embodiment of the invention, there is disclosed a method for providing heat transfer from a fluid comprising feeding the fluid into a storage unit comprising a storage bag and webs which are formed from a same film material wherein the fluid is fed into the storage bag, and feeding a heat transfer fluid into channels formed from webs in the storage bag wherein the webs are connected to an inner surface of a top surface and an inner surface of a bottom surface of the storage bag, wherein the heat transfer fluid in the channels contacts the fluid in the storage bag thereby transferring heat from the fluid.

The heat transfer fluid flows through the webs and cools/heats the product in the storage bag. The heat transfer fluid is physically separated from the storage bag.

The storage bag may be in a shape selected from the group consisting of square, rectangular, oval and round. Preferably, the storage bag is rectangular in shape having straight side edges and straight bottom and top edges wherein the length of the side edges is greater than the length of the top and bottom edges. The webs form channels in the interior of the storage bag.

The storage bag is flexible.

The webs are connected to the interior surface of the top surface and the interior surface of the bottom surface by a method selected from the group consisting of heat sealing, welding, thermo-contact (TC), radio frequency (RF) and gluing.

The channels that are formed from the webs comprise at east one layer inside of the storage bag.

The channels are in fluid communication with a fill nozzle.

Typically, the fluids that can be stored in the storage bags are bio-pharmaceutical products or solutions, typically long-chain molecules such as proteins, antibodies, vaccines, serums, or other medical fluids such as blood, plasma, infusions, urine, etc.

The heat transfer fluids that can be used in the present invention are selected from the group consisting of gaseous nitrogen and carbon dioxide, and mixtures thereof. In addition, any other liquid fluid which can be employed to exchange heat can be employed. It must be noted that in the event fluid acting as a heat exchange medium comes in contact with the fluids that are stored that contamination will result.

The heat transfer fluids will typically come from a gas supply system which will deliver the appropriate gas or mixtures thereof to the storage bag. Alternatively, a liquid fluid could be used as the heat transfer fluid. Advantage of neutral gases such as nitrogen, CO2 is that they do not contaminate the product during any leakages at the filling point or inside the bag.

Typically, the storage bag is made from a film which is selected from the group of ethylene vinyl acetate (EVA), poly vinyl chloride (PVC), polyethylene (LOPE, HDPE). Polyamide (PA), Polyethylene terephthalate (PET), polypropylene (PP), copolymer product contact layer of ethylene vinyl acetate and ethylene vinyl alcohol (available as Stedim 71 360 μm and EVAM 300 μm), and polyethylene product contact layer (available as Stedim 40).

Advantageously, as with the storage bag and the webs, the webs and resulting channels can be manufactured from the same materials that the storage bag is manufactured from.

By using the same material for both the storage bag and the webs and channels, the pressures and temperatures which the storage bag is subjected to will be normalized with respect to no undue shears or stresses being introduced into the storage bag by using materials of different compositions for the storage bag versus the webs and channels. Therefore, the operator can use the storage bag under the pressures and temperatures as prescribed for that type of storage bag material.

The webs and channels are fitted into the storage bag by heat sealing and welding to the inner surfaces of the storage bag. The channels can be one continuous path and typically when there are layers of channels, the layers can be fluidly connected to each other by appropriate means or they can remain separate.

The storage bags can accommodate a fairly wide range between 1 and 50 liters of fluid. Depending upon the application needs and fabrication process, larger or smaller size storage bags could also be realized.

The heat transfer fluids can be added to the storage bag in a manner whereby they fill the webs and channels to a certain pressure achieving an equilibrium with the fluid that is stored in the storage bag. Too low a pressure can allow the fluid that is stored in the bag to squeeze the webs and channels and inhibit the flow of the heat transfer fluid. This is an important consideration when filling the storage bag with fluid. If the fluid that is to be stored in the bag is prefilled before the webs and channels are formed, the formation of the webs and channels will be pressured by the static pressure of the stored fluid already present in the storage bag. One option is to pressurize the webs and channels with the heat transfer fluid before filling the storage bag with the fluid that is to be stored.

The storage bags can be filled in a chamber wherein the chamber atmosphere is cooled/heated or contact cooling/heating is employed. The fluid that is being stored will be further cooled by using the heat transfer fluid to fill the webs and channels within the storage bag. The storage bags can therefore be laid flat on a surface or hung vertically depending upon the setup of the operator.

The storage bag further comprises a fill nozzle in fluid communication with the storage bag for the product. The channels further comprise a fill nozzle in fluid communication with the channels for the heat transfer fluid.

Since the fluid in the storage bag needs to be kept at a relative fixed temperature, there will be occasions where the fluid needs to be raised in temperature as well as lowered in temperature. Accordingly, the heat transfer fluid can provide both a lowering and a raising of the temperature of the fluid within the storage bag. Typically, this can be accomplished by a flow control system for the heat transfer fluid.

The storage bag can further comprise an insertion slide-in on the middle layer where a thermocouple/element is able to measure the inside temperature of the storage bag. This can also be used for temperature control. The position in the bag is flexible depending where to measure the temperature e.g. several temperature elements along the channels can provide a temperature profile. During cooling the inlet temperature of the heat transfer fluid is colder than the outlet temperature. During heating vice versa. The storage bag will typically be held in a jig or other device which will allow an operator to attach filling means to the bag. Once the appropriate filling means are attached, the operator can begin filling the storage bag with the appropriate fluid. Once filled, the storage bag can be stored in a chamber which provide the appropriate temperature to the fluid in the storage bag. The heat transfer fluid can be added before or after the storage bags has been placed in the appropriate chamber.

### BRIEF DESCRIPTION OF THE DRAWINGS

FIG. 1 is an above-view schematic of the storage unit showing the heat transfer channels present therein.

FIG. 2 is a cross-sectional representation of the storage unit in FIG. 1 showing the location of the heat transfer channels.

FIG. 3 is a cross-sectional representation of a storage unit showing that the heat transfer channels are designed at the outer shell of the storage unit.

FIG. 4a is a cross-sectional representation of a storage unit as it shortens in length upon being filled with desired contents and the weld/channel layer is not in the center of the bag anymore.

FIG. 4b is a cross-sectional representation of a storage unit showing the effective length of the center layer.

FIG. 5 is a cross-sectional representation of a storage unit showing the interconnectivity of the multi-layers of heat transfer channels.

FIG. 6a is schematic of a temperature control element.

FIG. 6b is a schematic of a temperature control element in a group control environment.

FIG. 7 is a highlight of the input/output device for contents in the storage unit (tube-in-tube).

### DETAILED DESCRIPTION OF THE INVENTION

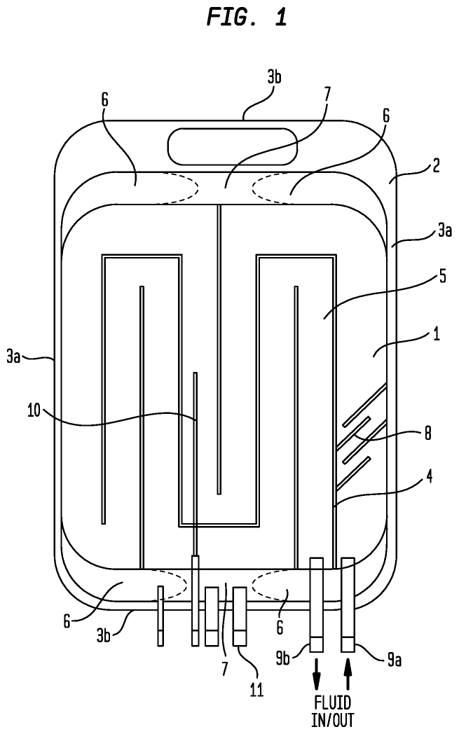

FIG. 1 is a schematic of a storage device with heat transfer channels according to the invention.

The storage bag 2 design can be used for heat transfer such as fluid heating, warming, thawing, ripening and cooling and freezing. Typically, this is accomplished with a liquid, cold gas or cryogenic gas such as nitrogen. Other media may also be employed for delivering either heat or cooling to the bag.

The storage device is shown laying on its side. The storage device is a bag assembly 2 which comprises two superimposed films 1 joined together by a welding technique, typically at points 3a and 3b at the top and bottom and left and right of the storage bag 2. The bag assembly 2 is orientated with a long side 3a and a short side 3b.

A fluid that is going to be stored in the bag assembly 2 is fed and/or removed the fluid through an input/output line 11 as needed by an operator. This input will typically possess the ability to be opened and closed mechanically such as by a stopcock or other valve mechanism (not shown).

Webs 4 provide the side walls for the channels 5. The webs 4 contact both the top and bottom of the two superimposed films 1 and are held in place with some adhesive such as paste for contact welding to be a more permanent joining. This is further represented by the webs 8 which contact the webs 4 to provide stability or extend the channel length, so the flow has a longer path to the webs 4 and the channels 5 produced therein. The channels 5 are formed while the heat transfer fluid (either a refrigerant or heating medium) is passed under pressure through the channels 5. The channels 5 must be formed before filling the storage bag 2 with fluid and it is anticipated that they may be formed after filling the storage bag with fluid. The fluid is typically not compressible and thus the channels 5 cannot be formed after filling. This is true when the filling of the storage bag 2 is done in the absence of ambient air and cannot form an air or gas bubble in the storage bag 2. To avoid a separate two chamber system in the storage bag 2, upper and/or lower section openings 6 are provided so that the fluid can be evenly distributed in the storage bag 2.

The heat transfer fluid is fed into the channels 5 created in the storage bag 2 through an input line 9A. A corresponding outlet line 9B is shown in close proximity to the input line 9A. The heat transfer fluid flows in at line 9A and flow out through line 9B. The biopharma fluid that is to be stored in the storage bag is fed through 11. There is no interconnection between the heat transfer fluid and storage fluid.

A temperature probe 10 may be inserted into an additional channel in the layer 1, so the temperature probe 10 is in the middle of the fluid that is being stored in the storage bag 2. The temperature probe can send an electric signal to the operator of the storage bag 2 to provide current temperature readings of the fluid therein. Typically, the temperature range is between about −60° C. and 60° C. However, this range can be expanding depending upon the film material specification as well as upon the stored fluid requirements. The temperature probe can communicate to the operator by either a quality monitoring system or a temperature control system depending upon the operator's setup. The operator can then make an adjustment, for example to raise or lower the temperature of the fluid in the storage bag 2 by adding the appropriate heat transfer fluid to the channels 5 through line 9A. The design also allows to insert multiple temperature probes, with the same technique mentioned above, to determine a temperature profile along the channel 5.

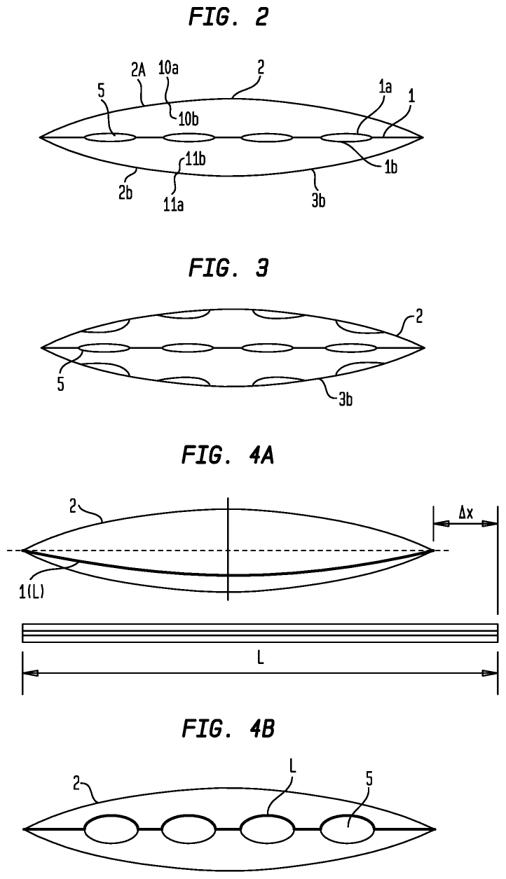

FIG. 2 is a schematic representation of the storage bag 2 in FIG. 1. In this view, the storage bag is being viewed from its side 3b rather than the top down orientation of FIG. 1. The channels 5 are shown within the center of the storage bag 2. Line 1 shows the welded films 1a and 1b. There are two films 1a and 1b needed to be able to create the channel. The films 1a and 1b will be superimposed that they can be welded at point 1. The complete storage bag will therefore have 4 layers of film. 1a and 1b for the heat transfer and film 2 for defining the storage. At their edges the four layers will be welded.

Further, FIG. 2 shows the top surface 2A of the storage bag 2 as well as the bottom surface 2B. Each of these surfaces 2A and 2B will have an exterior surface and an interior surface. These designations are intended to provide proper identification of the interior and exterior of the storage bag for spatial purposes. In particular, the exterior surface of the top surface 2A will be designated 10A while its corresponding interior surface will be designated 10B. The bottom surface 2B has an exterior surface 11A and an interior surface 11B.

FIG. 3 is another view of the storage bag 2 viewed from its side 3b. In this view, multiple layers of channels 5 are present in the storage bag 2 for allowing passage of heat transfer fluid through multiple levels of the storage bag 2. In this embodiment, it is shown that the channels that circulated the heat transfer fluid can be attached to the outside of the storage bag as well as being present inside of the storage bag. By virtue of this embodiment, there would be a total of six layers of film present in this storage bag structure.

FIG. 4a is a sideways view of a storage bag 2 showing the change in the width Δx of the storage bag 2 as a consequence of being filled with fluid. The empty storage bag 2 has a length L shown at the bottom of the figure. When the filling of the storage bag 2 with fluid is complete, the width of the storage bag 2 has expanded while its length has decreased by an arbitrary distance Δx. A consequence then of the filling of the bag with fluid is that the middle layer 1 with the channels that provide the heat transfer fluid may no longer be centered in the storage bag 2. This is especially the situation encountered while the channels are not filled with heat transfer fluid.

The remedy for this is shown in FIG. 4b where the design of the channels 5 is designed so that their height is taken into account when channels are filled with heat transfer fluid and the storage bag 2 is partially or fully filled with fluid. The channels 5 can have a corresponding curvature length L such that the channels will remain in the middle of the storage bag 2, and hence the fluid to optimize heat transfer to the fluid.

FIG. 5 is an alternative view of the storage bag 2 shown in FIG. 3. In this schematic, the storage bag 2 is shown from its side view 3b from the bottom up and shows an expanded storage bag 2 filled with fluid and the relative positioning of the several channels 5 that are separated into three distinct layers to provide heat transfer throughout the fluid present in the storage bag 2.

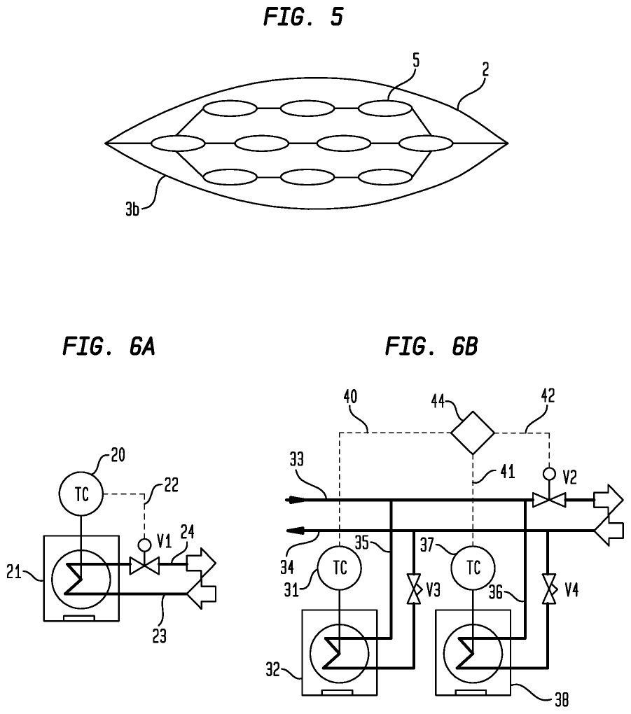

FIG. 6A is a schematic showing that temperature control can be achieved when some form of temperature measurement of the fluid in a storage bag is retrieved by an operator. The temperature element can provide data for temperature control for either cooling or heating of the fluid that is present in the storage bag. The measurements of temperature then can be transmitted to the operator who can in turn respond to the measurement by increasing or decreasing depending upon the nature of the fluid the amount of heat transfer that is applied thereto.

Line 23 represents the flow of heat transfer fluid into storage device 21 while line 24 represents the flow of heat transfer fluid from the storage device 21. A temperature control unit 20 measures the temperature of the contents of the storage device 21. The control unit 20 can instruct through electrical connection 22 valve V1 whether to open up or close depending upon whether the operator wishes, based on the reading of control unit 20 whether to raise or lower the temperature of the fluid in storage device 21. The position of valve V1 at the outlet line 24 has the advantage that the channels are always pressurized with heat transfer fluid, so the channels won't collapse during operation.

FIG. 6b represents a situation where there is a group control scheme maintained by the operator. In this embodiment, two storage units 32 and 38 respectively are having the temperature of their fluid contents being measured through temperature control units 31 and 37 respectively. The heat transfer fluid is fed through line 33 and line 35 where it will transfer through open valve V3 to line 34. Likewise line 33 delivers heat transfer fluid to line 36 for feed into storage device 38. When valve V4 is open, the heat transfer fluid is fed to line 34 where it will exit the system.

The temperature control schemes will provide electronic signals through lines 40 and 41 respectively to a central control hub 44. From there, the operator can mechanically or through pre-programmed statuses direct electronically through line 42 to open or close valve V2 which will allow for more or less ingress of temperature control fluid into the respective storage devise 32 and 38. In this manner, the central control hub will allow an operator to not only monitor the temperature in two or more storage devices but will allow the operator to adjust the temperatures of the fluid in those devices accordingly. This lends greater control to the operations while also allowing the operator to use one source line of heat transfer fluid.

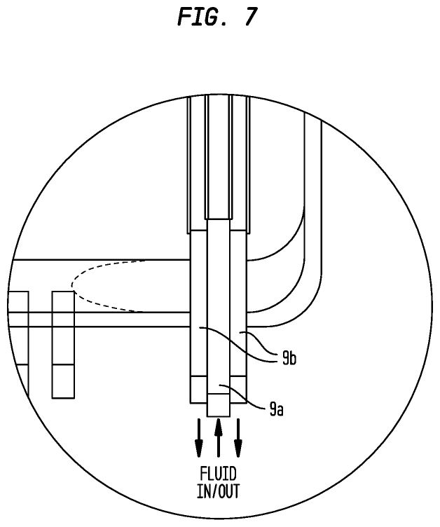

FIG. 7 is a blow-up detail of the fluid lines in and out (9a and 9b) from FIG. 1. Here rather than two tubes as shown in FIG. 1, there are two tubes in this embodiment. It is a tube-in-tube connection. The fluid tube in 9a is insert in tube 9b for allowing the transfer of fluid out of the storage bag as detailed in FIG. 1. This could be accomplished by a tube-in-tube structure wherein a single tube encompasses both the line for inputting heat transfer medium and outputting heat transfer medium into the appropriate storage device.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what I claim is:

1. A storage unit comprising a storage bag and webs, wherein the storage bag comprises a top and a bottom surface wherein the top and the bottom surfaces have an interior surface and an exterior surface and the top surface and the bottom surface each have edges wherein the edges are sealed together, and the webs are connected to the inner surface of the top surface and the inner surface of the bottom surface, wherein the storage bag and the webs are made from film materials that are the same.

2. The storage unit as claimed in claim 1 wherein the storage bag is in a shape selected from the group consisting of square, rectangular, oval and round.

3. The storage unit as claimed in claim 2 wherein the storage bag is rectangular in shape having straight side edges and straight bottom and top edges wherein the length of the side edges is greater than the length of the top and bottom edges.

4. The storage unit as claimed in claim 1 wherein the film materials are selected from the group consisting of ethylene vinyl acetate (EVA), poly vinyl chloride (PVC), polyethylene (LDPE, HDPE). Polyamide (PA), Polyethylene terephthalate (PET), polypropylene (PP), and ethylene vinyl alcohol copolymer and polyethylene.

5. The storage unit as claimed in claim 1 wherein the webs form channels in the interior of the storage bag.

6. The storage unit as claimed in claim 1 wherein the storage bag is flexible.

7. The storage unit as claimed in claim 1 wherein the webs are connected to the interior surface of the top surface and the interior surface of the bottom surface by a method selected from the group consisting of heat sealing, welding, thermo-contact (TC), radio frequency (RE) and gluing.

8. The storage unit as claimed in claim 5 wherein the channels that are formed comprise at least one layer inside of the storage bag.

9. The storage unit as claimed in claim 8 wherein the channels are in fluid communication with a fill nozzle.

10. A method for providing heat transfer from a fluid comprising feeding the fluid into a storage unit comprising a storage bag and webs which are formed from a same film material wherein the fluid is fed into the storage bag, and feeding a heat transfer fluid into channels formed from webs in the storage bag wherein the webs are connected to an inner surface of a top surface and an inner surface of a bottom surface of the storage bag, wherein the heat transfer fluid in the channels contacts the fluid in the storage bag thereby transferring heat from the fluid.

11. The method as claimed in claim 10, wherein the storage bag is in a shape selected from the group consisting of square, rectangular, oval and round.

12. The method as claimed in claim 10 wherein the storage bag is rectangular in shape having straight side edges and straight bottom and top edges wherein the length of the side edges is greater than the length of the top and bottom edges.

13. The method as claimed in claim 10 wherein the film materials are selected from the group consisting of ethylene vinyl acetate (EVA), poly vinyl chloride (PVC), polyethylene (LDPE, HDPE). Polyamide (PA), Polyethylene terephthalate (PET), polypropylene (PP), and ethylene vinyl alcohol copolymer and polyethylene.

14. The method as claimed in claim 10 wherein the storage bag is flexible.

15. The method as claimed in claim 10 wherein the webs are connected to the interior surface of the top surface and the interior surface of the bottom surface by a method selected from the group consisting of heat sealing, welding and gluing.

16. The method as claimed in claim 10 wherein the channels that are formed comprise at least one layer inside of the storage bag.

17. The method as claimed in claim 15 wherein the channels filled through a fill nozzle.

18. The method as claimed in claim 10 wherein the fluid is a bio-pharmaceutical and medical product.

19. The method as claimed in claim 10 wherein the heat transfer fluid is selected from the group consisting of gaseous nitrogen, gaseous carbon dioxide and mixtures thereof.
